(19) United States
(12) Patent Application Publication
(10) Pub. No.: US 2026/0103298 A1
(43) Pub. Date: Apr. 16, 2026

(54) RESISTING ABLATION OF VEHICLE NOSE TIP

(71) Applicant: Textron Systems Corporation, Hunt Valley, MD (US)

(72) Inventors: Michael Robert Favaloro, Amesbury, MA (US); James Gerard Crowley, Arlington, MA (US); Mitchell Simon Uretsky, Andover, MA (US)

(21) Appl. No.: 19/352,952

(22) Filed: Oct. 8, 2025

Related U.S. Application Data
(60) Provisional application No. 63/707,465, filed on Oct. 15, 2024.

(51) Int. Cl. B64G 1/58; B64G 1/62; B64G 99/00

(52) U.S. Cl. CPC B64G 1/58; B64G 1/62; B64G 99/00

(57) ABSTRACT

A nose tip for a vehicle includes a nose body, an insulative layer that covers at least a portion of the nose body, and an outer skin that covers and encloses the insulative layer. The insulative layer is constructed and arranged to receive a coolant for protecting the nose body from heat during entry of the vehicle into an atmosphere.

### CROSS-REFERENCE TO RELATED APPLICATIONS: THIS APPLICATION CLAIMS THE

benefit of U.S. Provisional Application No. 63/707,465, filed on Oct. 15, 2024, the contents and teachings of which are incorporated herein by reference in their entirety.

### BACKGROUND

A vehicle entering the atmosphere of the earth or another planetary body from space can experience exceedingly high temperatures. Such vehicles are equipped with nose tips, which experience the highest temperatures, as friction with the atmosphere causes air on the windward side of the nose tips to transform into a hot plasma. To reduce damage and ensure vehicle survivability, nose tips are typically composed of multi-directionally reinforced composites designed to withstand extremely high heat while remaining structurally intact. Carbon-based materials reinforced with carbon fiber are generally preferred for this purpose, given their structural strength and high heat of ablation.

### SUMMARY

Unfortunately, conventional nose tips can suffer significant ablation upon entry into the atmosphere, even if they are composed of carbon composite materials. “Ablation” refers to mass loss due to high-temperature erosion. Effects of ablation can be severe and can prevent a vehicle from successfully completing its mission. Such ablation can also present significant challenges to reusability. As a result, a nose tip that is more resistant to ablation is needed.

The above need is addressed at least in part with an improved technique in which a nose tip having an outer skin covers a thermally insulative layer infused with a coolant. Advantageously, the coolant-infused insulative layer delays an onset of ablation and resists overheating of the nose tip and its components. These features promote reliability and potential reusability of the nose tip for future missions.

Certain embodiments are directed to a nose tip for a vehicle. The nose tip includes a nose body, an insulative layer that covers at least a portion of the nose body, and an outer skin that covers and encloses the insulative layer. The insulative layer is constructed and arranged to receive a coolant for protecting the nose body from heat during entry of the vehicle into an atmosphere. “Entry” of the vehicle should be understood to include original entry as well as reentry.

According to one or more embodiments, the vehicle may be provided as a high-speed rocket, a module or pod, or any other vehicle designed to enter the atmosphere.

According to one or more further embodiments, the insulative layer is composed at least in part of material having a porous, open-cell structure.

According to one or more further embodiments, the nose tip further includes a coolant reservoir constructed and arranged to release the coolant into the insulative layer on command.

According to one or more further embodiments, the coolant is composed of at least one of (i) noble gas, (ii) sodium, or (iii) water.

According to one or more further embodiments, the coolant is composed at least in part of noble gas, and the nose tip further includes a ballast circuit constructed and arranged to excite the noble gas to form a cold plasma within the insulating layer.

According to one or more further embodiments, the outer skin is composed of a carbon-carbon material.

According to one or more further embodiments, the carbon-carbon material of the outer skin includes carbon fiber that runs in an axial direction to conduct heat from an upper region of the nose tip to a lower region of the nose tip during entry of the vehicle into the atmosphere.

According to one or more further embodiments, the nose tip further includes an inner skin disposed between the nose body and the insulative layer. The inner skin and the outer skin form a container that resists leakage of the coolant.

According to one or more further embodiments, the inner skin includes carbon fiber that runs in one of an axial direction and a circumferential direction, and the outer skin includes carbon fiber that runs in the other of the axial direction and the circumferential direction.

Other embodiments are directed to a method of manufacturing a nose tip for a vehicle. The method includes additively applying carbon fiber over a nose body to form an inner skin, applying an insulative layer over inner skin, the insulative layer having a porous, open-cell structure constructed and arranged to distribute a coolant throughout the insulative layer, and additively applying carbon fiber over the insulative layer to form an outer skin.

According to one or more further embodiments, additively applying carbon fiber over the nose body to form the inner skin includes arranging the carbon fiber to run in a circumferential direction.

According to one or more further embodiments, additively applying carbon fiber over the nose body to form the outer skin includes arranging the carbon fiber to run in an axial direction.

Still further embodiments are directed to a method of controlling the temperature of a nose tip of a vehicle. The method includes providing an insulative layer over a nose body of the nose tip, providing an outer skin over the insulative layer, and releasing coolant into the insulative layer, such that the coolant is transported throughout the insulative layer for protecting the nose body from overheating during entry of the vehicle into an atmosphere.

According to one or more further embodiments, the insulative layer is provided as a layer of material having a porous, open-cell structure.

According to one or more further embodiments, releasing the coolant includes opening a container of the coolant, such that at least some of the coolant escapes the container and permeates throughout the insulative layer.

According to one or more further embodiments, the coolant includes noble gas, and the method further includes activating a ballast circuit to excite the noble gas such that the noble gas forms a cold plasma within the insulating layer.

According to one or more further embodiments, releasing the coolant further includes introducing the coolant into the insulative layer at an upper region of the nose body, such that the coolant spreads downwardly from the upper region and permeates the insulative layer.

According to one or more further embodiments, the outer skin includes carbon fiber that runs in an axial direction, and the method further comprises conducting heat through the carbon fiber in the axial direction to cool an upper region of the nose tip.

According to one or more further embodiments, the method further includes providing an inner skin between the nose body and the insulative layer, and containing the coolant between the inner skin and the outer skin.

According to one or more further embodiments, the inner skin includes carbon fiber that runs in a circumferential direction, and the method further includes conducting heat through the carbon fiber in the circumferential direction from a windward side of the nose tip to a leeward side of the nose tip.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is an upper perspective view of a nose tip according to one or more embodiments.

FIG. 2 is an elevated side view of an example vehicle according to one or more embodiments.

FIG. 3 is a front cross-sectional view of the nose tip of FIG. 1 according to one or more embodiments.

FIG. 4 is a front cross-sectional view of an alternative nose tip according to one or more embodiments.

FIGS. 5A and 5B are respectively front cross-section views (FIG. 5A) and upper perspective views (FIG. 5B) of the nose tips of FIGS. 1 and 4 according to one or more embodiments.

FIG. 6 is a flowchart that shows an example method of manufacturing a nose tip for a vehicle, according to one or more embodiments.

FIG. 7 is a flowchart that shows an example method of controlling the temperature of a nose tip of a vehicle, according to one or more embodiments.

### DETAILED DESCRIPTION

An improved technique provides a nose tip for a vehicle. The nose tip has an outer skin that covers a thermally insulative layer infused with a coolant. The coolant-infused insulative layer delays an onset of ablation and resists overheating of the nose tip and its components, promoting reliability and reusability of the nose tip for future missions.

According to one or more embodiments, the insulative layer includes a material having a porous, open-cell structure that allows coolant having the form of a gas or cold plasma to permeate throughout the insulative layer, providing a cooling effect in the outer skin and a heat-insulative effect for protecting internal structures of the nose tip.

According to one or more embodiments, the coolant includes one or more noble gases, such as argon gas and/or helium gas, which may be excited to form a cold plasma. The resulting cold plasma within the insulative layer presents an additional barrier to hot plasma that forms outside the nose tip.

According to one or more embodiments, the outer skin is composed at least in part of carbon fiber arranged axially along the nose tip. Carbon fiber is known to have high thermal conductivity, and thus the axial arrangement of carbon fiber has the effect of drawing heat from an upper region of the nose tip, where friction-induced heating from the atmosphere is the greatest, to a lower region of the nose tip, further delaying the onset of ablation.

According to one or more embodiments, the nose tip further includes an inner skin disposed between the insulative layer and a body of the nose tip. The inner skin is composed at least in part of carbon fiber arranged circumferentially around the nose tip. The circumferential arrangement of carbon fiber has the effect of drawing heat from a windward side of the nose tip, where heating is the greatest, to a leeward side of the nose tip, further delaying the onset of ablation.

Embodiments of the improved technique will now be described. One should appreciate that such embodiments are provided by way of example to illustrate certain features and principles but are not intended to be limiting.

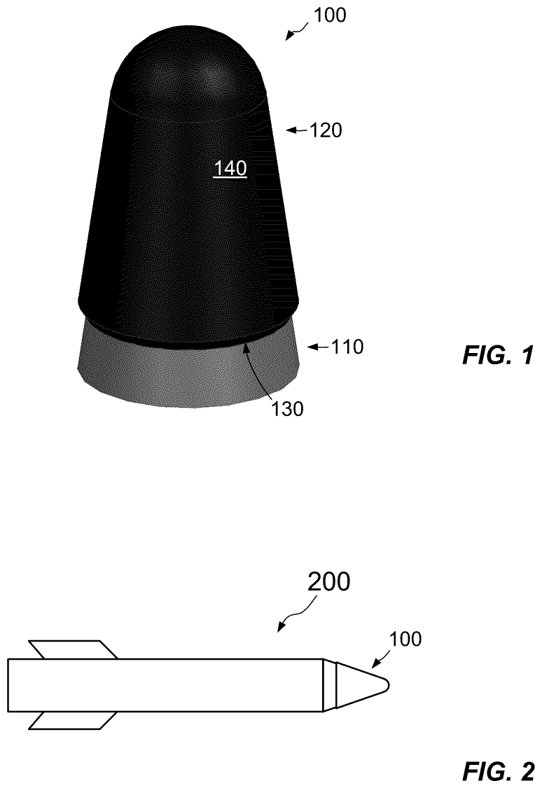

FIGS. 1 and 2 show an example nose tip 100 according to one or more embodiments. The nose tip 100 includes a nose body 110 and a nose shield 120 applied over the nose body 110. The nose shield 120 has an inner skin 130 and an outer skin 140.

Although not visible in FIG. 1, the nose shield further includes a thermally insulative layer 150 disposed between the inner skin 130 and the outer skin 140. The nose tip 100 may be part of a vehicle 200, as shown in FIG. 2. Although FIG. 2 shows a high-speed rocket, the vehicle 200 may alternatively be a module, pod, or any other vehicle designed to enter or reenter the atmosphere.

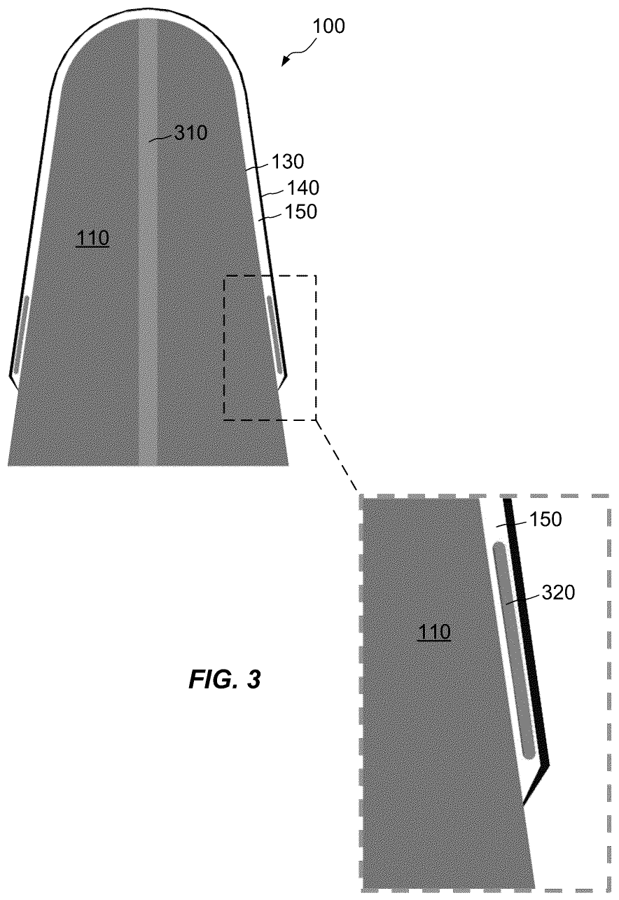

FIG. 3 shows a cross-sectional view of the nose tip 100 according to one or more embodiments. In this example, the inner skin 130 may be a distinct structure disposed over the nose body 110 or it may correspond to an outer surface of the nose body itself. The insulative layer 150 may be composed of one or more materials having a porous, open-cell structure, which allows fluids (e.g., liquids, gases, plasma, etc.) to permeate throughout the insulative layer 150. Suitable substances may include inorganic or organic materials, and may include polymerized materials, such as foams, or non-polymerized materials. Examples of suitable materials for the insulative layer 150 include the following:
Aerogel, such as a layer of aerogel material or one or more aerogel panels. The aerogel may be silica-based or carbon-based. One source of such material is Blue Shift Materials of Spencer, MA;
Duocel® foam, which is available in both carbon ceramic and metallic form from ERG Aerospace of Sparks, NV;
MSE porous carbon foam, which is available from MSE Supplies® of Tucson, AZ;
Ultramet open-cell carbon and ceramic foams, which is available from Ultramet of Pacoima, CA.

In some arrangements, the nose body 110 is composed of a carbon-carbon material, such as carbon fiber of various orientations disposed in a graphitic carbon substrate. The nose body 110 may be manufactured as a billet and machined to a desired shape. However, the nose body 110 may be composed of other materials, such as metal or composite. In some arrangements, the nose body 110 has a metallic core 310 composed of tantalum carbide, which provides a measure of shock resistance when the vehicle 200 encounters water or dust particles at high speeds. Also, the nose body 110 may be equipped with electrical and mechanical components for performing various functions as described herein.

As further shown in FIG. 3, the nose tip 100 includes a container 320 within the insulative layer 150. An annular-shaped container is shown. The container 320 holds a coolant, such as noble gas (e.g., argon and/or helium), sodium, or water. Alternative arrangements may place the container 320 outside the insulative layer 150, with plumbing provided for transporting the coolant into the insulative layer.

According to one or more embodiments, the container 320 is constructed and arranged to release the coolant on command. Once released, the coolant quickly spreads throughout the insulative layer 150 by virtue of its porous, open-cell structure. The inner and outer skins 130 and 140 surround and contain the coolant within the insulative layer.

Additional equipment may be provided for activating the coolant. For example, the nose tip 100 may include a ballast circuit for transforming noble gas into a cold plasma, in much the same way that the ballast of a fluorescent lightbulb causes the enclosed vapor to illuminate. If the coolant is sodium or water, a heater may be provided for transforming the coolant into a gaseous state.

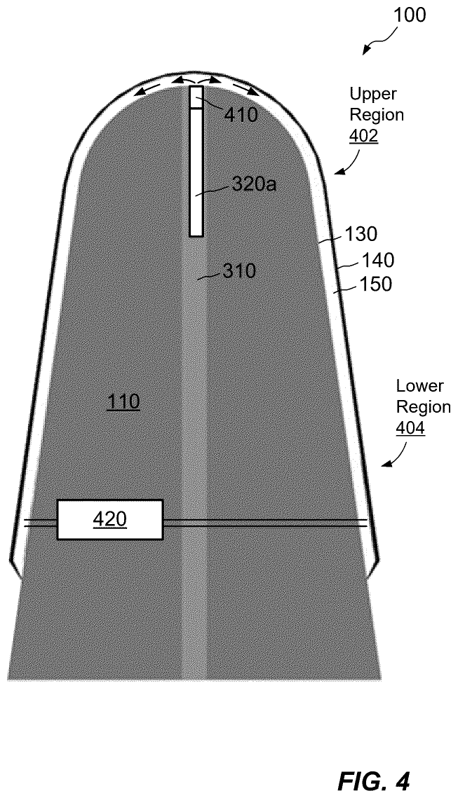

FIG. 4 shows another coolant container according to one or more embodiments. Here, a container 320a is disposed centrally within the nose tip 100, such as within an inner cavity of the tantalum carbide core 310. In this example, the container 320a holds a supply of compressed noble gas. A valve 410 is provided for selectively opening to release the noble gas into the insulative layer 150 at an upper region 402 of the nose tip 100, rather than at a lower region 404 as in FIG. 3. The FIG. 4 arrangement dispenses the coolant where it is needed most, i.e., at the upper region 402 of the nose tip, which normally experiences the greatest and fastest heating. A ballast circuit 420 may be provided to activate the noble gas to form cold plasma. Although not shown, various other components may be included in the nose tip 100 or other parts of the vehicle 200, such as one or more batteries, electronic controllers, sensors, and the like. The valve 410 may be opened and the ballast circuit 420 may be activated on command, such as in response to the vehicle 200 detecting that it is beginning to enter the atmosphere.

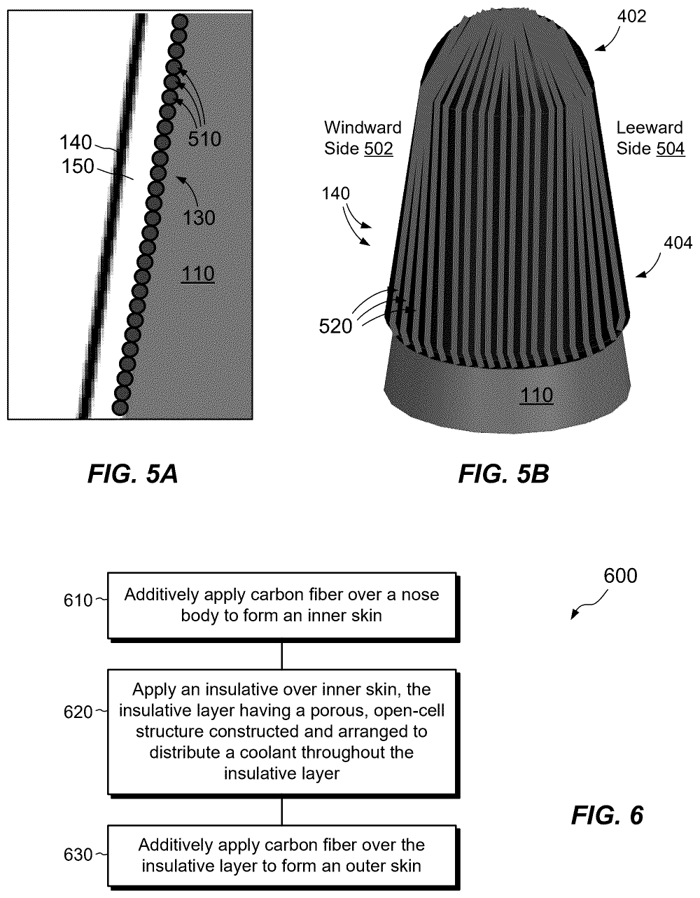

FIGS. 5A and 5B show example constructions of the inner skin 130 (FIG. 5A) and outer skin 140 (FIG. 5B) according to one or more embodiments. In FIG. 5A the inner skin 130 is composed at least in part of carbon fiber 510 arranged circumferentially, i.e., in circular or spiral paths that wind around the outer surface of the nose body 110. In FIG. 4B, the outer skin 140 is composed at least in part of carbon fiber 520 arranged axially, i.e., in vertical paths that run over the insulative layer 150.

Given the high thermal conductivity of carbon fiber, the circumferential fibers 510 of the inner skin 130 tend to transfer heat from a hotter, windward side 502 of the nose tip 100 (FIG. 5A) to a cooler, leeward side 504 of the nose tip 100. Also, the axial fibers 520 of the outer skin 140 tend to transfer heat from a hotter, upper region 402 of the nose tip 100 (FIG. 5B) to a cooler, lower region 404 of the nose tip 100. Thus, the orientation of fibers in the inner skin 130 and the outer skin 140 promote cooling of the nose tip 100 and further delay the onset of ablation.

FIG. 6 shows an example method 600 of manufacturing the nose tip 100 according to one or more embodiments. At 610, carbon fiber is additively applied over the nose body 100 to form the inner skin 130. For example, the carbon fiber is saturated in a carbon matrix and laid down directly onto the nose body 110. At 620, an insulative layer 150 is applied over the inner skin 130. At 630, carbon fiber is additively applied over the insulative layer 150 to form the outer skin 140. For example, the carbon fiber is saturated in a carbon matrix and laid down directly onto the insulative layer 150.

In some arrangements, the outer skin 140 is composed of pitch carbon fiber, which provides extremely high thermal conductivity. The inner skin 130 may also be composed of pitch carbon fiber. Alternatively, the inner skin 130 may be composed of rayon carbon fiber, which has lower thermal conductivity than pitch carbon fiber. The rayon fiber in this example can improve thermal insulation for protecting the nose body 110. One should appreciate that the details of construction described above may be varied and that such details are provided for illustration and are not intended to be limiting.

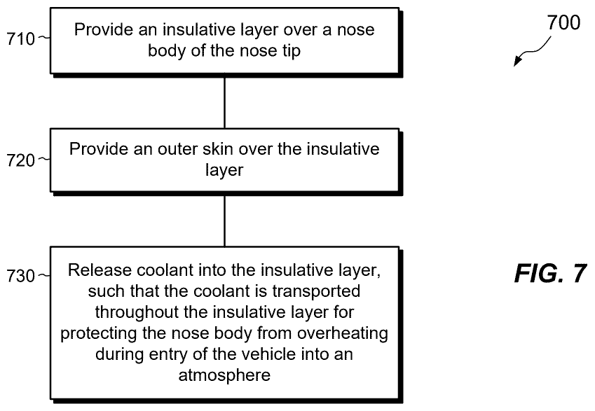

FIG. 7 shows an example method 700 of controlling the temperature of a nose tip 100 of a vehicle 200, according to one or more embodiments. At 710, an insulative layer 150 is provided over a nose body 110 of the nose tip 100. The insulative layer 150 has a porous, open-cell structure, and may be provided directly over the nose body 110 or over an inner skin 130, as described above. At 720, an outer skin 140 is provided over the insulative layer 150. These “providing” steps 710 and 720 may be performed merely by using the nose tip 100, which may already have been manufactured to include the insulative layer 150 and the outer skin 140. “Providing” in these steps may thus be interpreted as “providing for use.” At 730, coolant is released into the insulative layer 150, such that the coolant is transported throughout the insulative layer 150 for protecting the nose body 110 from overheating during entry of the vehicle 200 into the atmosphere.

An improved technique has been described in which a nose tip 100 having an outer skin 140 covers a thermally insulative layer 150 infused with a coolant. Advantageously, the coolant-infused insulative layer delays an onset of ablation and resists overheating of the nose tip 100 and its components. These features promote reliability of the vehicle 200 and potential reusability of the nose tip 100 for future missions.

Having described certain embodiments, numerous alternative embodiments or variations can be made. For example, although the inner skin 130 and the outer skin 140 have been described as added structures, this is not required. For example, panels of aerogel or other insulative material may be purchased with skins already applied. These skins may be sufficient for certain applications. Also, as mentioned above, the inner skin 130 may be formed as an outer surface of the nose base 110.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A nose tip for a vehicle, comprising:
a nose body;
an insulative layer that covers at least a portion of the nose body; and
an outer skin that covers and encloses the insulative layer, wherein the insulative layer is constructed and arranged to receive a coolant for protecting the nose body from heat during entry of the vehicle into an atmosphere.

2. The nose tip of claim 1, wherein the insulative layer is composed at least in part of material having a porous, open-cell structure.

3. The nose tip of claim 2, further comprising a coolant reservoir constructed and arranged to release the coolant into the insulative layer on command.

4. The nose tip of claim 3, wherein the coolant is composed of at least one of (i) noble gas, (ii) sodium, or (iii) water.

5. The nose tip of claim 3, wherein the coolant is composed at least in part of noble gas, and wherein the nose tip further comprises a ballast circuit constructed and arranged to excite the noble gas to form a cold plasma within the insulating layer.

6. The nose tip of claim 3, wherein the outer skin is composed of a carbon-carbon material.

7. The nose type of claim 6, wherein the carbon-carbon material of the outer skin includes carbon fiber that runs in an axial direction to conduct heat from an upper region of the nose tip to a lower region of the nose tip during entry of the vehicle into the atmosphere.

8. The nose tip of claim 3, further comprising an inner skin disposed between the nose body and the insulative layer, wherein the inner skin and the outer skin form a container that resists leakage of the coolant.

9. The nose tip of claim 8, wherein the inner skin includes carbon fiber that runs in one of an axial direction and a circumferential direction, and wherein the outer skin includes carbon fiber that runs in the other of the axial direction and the circumferential direction.

10. A method of manufacturing a nose tip for a vehicle, comprising:
additively applying carbon fiber over a nose body to form an inner skin;
applying an insulative layer over inner skin, the insulative layer having a porous, open-cell structure constructed and arranged to distribute a coolant throughout the insulative layer; and
additively applying carbon fiber over the insulative layer to form an outer skin.

11. The method of claim 10, wherein additively applying carbon fiber over the nose body to form the inner skin includes arranging the carbon fiber to run in a circumferential direction.

12. The method of claim 11, wherein additively applying carbon fiber over the nose body to form the outer skin includes arranging the carbon fiber to run in an axial direction.

13. A method of controlling temperature of a nose tip of a vehicle, comprising:
providing an insulative layer over a nose body of the nose tip;
providing an outer skin over the insulative layer; and
releasing coolant into the insulative layer, such that the coolant is transported throughout the insulative layer for protecting the nose body from overheating during entry of the vehicle into an atmosphere.

14. The method of claim 13, wherein the insulative layer is provided as a layer of material having a porous, open-cell structure.

15. The method of claim 14, wherein releasing the coolant includes opening a container of the coolant, such that at least some of the coolant escapes the container and permeates throughout the insulative layer.

16. The method of claim 15, wherein the coolant includes noble gas, and wherein the method further comprises activating a ballast circuit to excite the noble gas such that the noble gas forms a cold plasma within the insulating layer.

17. The method of claim 16, wherein releasing the coolant further includes introducing the coolant into the insulative layer at an upper region of the nose body, such that the coolant spreads downwardly from the upper region and permeates the insulative layer.

18. The method of claim 14, wherein the outer skin includes carbon fiber that runs in an axial direction, and wherein the method further comprises conducting heat through the carbon fiber in the axial direction to cool an upper region of the nose tip.

19. The method of claim 14, further comprising providing an inner skin between the nose body and the insulative layer, and containing the coolant between the inner skin and the outer skin.

20. The method of claim 19, wherein the inner skin includes carbon fiber that runs in a circumferential direction, and wherein the method further comprises conducting heat through the carbon fiber in the circumferential direction from a windward side of the nose tip to a leeward side of the nose tip.
